(19) United States
(12) Patent Application Publication
(10) Pub. No.: US 2023/0402694 A1
(43) Pub. Date: Dec. 14, 2023

(54) BATTERY PACK AND VEHICLE

(71) Applicant: TOYOTA JIDOSHA KABUSHIKI KAISHA, Toyota-shi (JP)

(72) Inventor: Yoshiro KAMO, Ashigarakami gun (JP)

(73) Assignee: TOYOTA JIDOSHA KABUSHIKI KAISHA, Toyota-shi (JP)

(21) Appl. No.: 18/134,237

(22) Filed: Apr. 13, 2023

(30) Foreign Application Priority Data
Jun. 10, 2022 (JP) 2022-094334

(51) Int. Cl. H01M 50/242; H01M 50/204; H01M 10/6554; H01M 50/293

(52) U.S. Cl. CPC H01M 50/242; H01M 50/204; H01M 10/6554; H01M 50/293; H01M 2220/20

(57) ABSTRACT

A battery pack comprises: a plurality of battery modules (or stacks) stacked in a Z direction, and each including a plurality of metal foils (or metal plates) stacked in the Z direction. The battery pack also comprises a resin portion bonded to a peripheral portion of the plurality of battery modules, and a case that houses the plurality of battery modules. The battery pack also comprises a stopper (or a regulating portion) that is disposed in the case so as to face the resin portion. In a direction in which the resin portion and the stopper face each other, the resin portion has a width equal to or larger than a distance between the resin portion and the stopper.

This nonprovisional application is based on Japanese Patent Application No. 2022-094334 filed on Jun. 10, 2022 with the Japan Patent Office, the entire contents of which are hereby incorporated by reference.

### BACKGROUND

### Field

The present disclosure relates to a battery pack and a vehicle.

### Description of the Background Art

Japanese Patent laying-Open No. 2021-174632 discloses a power storage device in which a plurality of power storage modules are stacked. Each of the plurality of power storage modules is provided with an electrical connection surface (active portion) on an end surface of the plurality of stacked modules in the stacking direction. The connection surfaces (active portions) of the storage modules stacked on each other are brought into contact with each other, whereby the storage modules stacked on each other are electrically connected to each other.

### SUMMARY

However, according to Japanese Patent Application Laying-Open No. 2021-174632, when any one of the plurality of power storage modules laterally slips due to vibration or the like, the electrical connection surface (or active portion) of the power storage module may be exposed. Therefore, it is desired to suppress exposure of the active portion of the power storage module (or a stack).

The present disclosure has been made in order to address the above issue and contemplates a battery pack and vehicle capable of suppressing exposure of an active portion of a stack.

According to a first aspect of the present disclosure, a battery pack comprises: a plurality of stacks stacked in a first direction, and each including a plurality of metal plates stacked in the first direction; a resin portion bonded to a peripheral portion of the plurality of stacks; a case that houses the plurality of stacks; and a regulating portion that is disposed in the case so as to face the resin portion in a second direction orthogonal to the first direction and regulates movement of each of the plurality of stacks. In the second direction, the resin portion has a width equal to or larger than a distance between the resin portion and the regulating portion.

In the battery pack according to the first aspect of the present disclosure, as described above, in the second direction in which the resin portion and the regulating portion face each other, the resin portion has a width equal to or larger than the distance between the resin portion and the regulating portion. Thus, even when one of the plurality of stacks laterally slips and the resin portion bonded to the one stack comes into contact with the regulating portion, projection of the one stack toward the regulating portion with respect to the other stack can be suppressed. As a result, exposure of the metal plate (or active portion) provided in the one stack at an end portion in the stacking direction can be suppressed.

The battery pack according to the first aspect preferably comprises a conductive plate adjacent to at least one of the plurality of stacks in the first direction and thus electrically connected to the at least one stack. The conductive plate has an overlapping portion provided so as to overlap the resin portion in the first direction. In the second direction, the overlapping portion has a width equal to or larger than the distance between the resin portion and the regulating portion. According to this configuration, when one of the plurality of stacks laterally slips and the resin portion bonded to the one stack comes into contact with the regulating portion, overlapping between the resin portion of the one stack and the conductive plate is maintained (that is, the overlapping portion remains), and projection of the active portion from the conductive plate toward the regulating portion can be suppressed. As a result, exposure of the active part can further be suppressed.

In the battery pack according to the first aspect, preferably, the peripheral portion of the plurality of stacks to which the resin portion is bonded is provided along the entire periphery of the plurality of stacks. The regulating portion is provided so as to surround the entire periphery of the resin portion when viewed in the first direction. The resin portion is formed such that, along its entire periphery, a width of the resin portion in the second direction opposing the regulating portion is equal to or larger than the distance between the resin portion and the regulating portion in the second direction. This configuration can suppress exposure of the active portion even when the stack slides in any lateral direction.

In the battery pack according to the first aspect, the width of the resin portion in the second direction is preferably larger than a thickness of each of the plurality of metal plates in the first direction. According to this configuration, the resin portion can be relatively increased in mechanical strength, and can thus more reliably protect the stack (or metal plate) when the stack laterally slips and comes into contact (or collides) with the regulating portion.

In the battery pack according to the first aspect, preferably, the regulating portion is formed of an insulating resin. This configuration ensures insulation between the regulating portion and the stack even when the stack laterally slides and comes into contact with the regulating portion.

According to a second aspect of the present disclosure, a vehicle has mounted therein the battery pack according to the first aspect. The vehicle can thus suppress exposure of the active portion of the stack.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an electric vehicle equipped with a battery pack according to an embodiment.

FIG. 2 is a cross-sectional view showing the configuration of the battery pack according to the present embodiment.

FIG. 3 is a partially enlarged view of the vicinity of a gap between a resin portion and a stopper in FIG. 2.

FIG. 4 is a plan view of the battery pack according to the embodiment.

FIG. 5 is a cross-sectional view showing a state in which one battery module of the battery pack according to the embodiment slips.

### DESCRIPTION OF THE PREFERRED EMBODIMENTS

Hereinafter, embodiments of the present invention will be described in detail with reference to the accompanying drawings. In the drawings, the same or corresponding parts are denoted by the same reference numerals, and the description thereof will not be repeated.

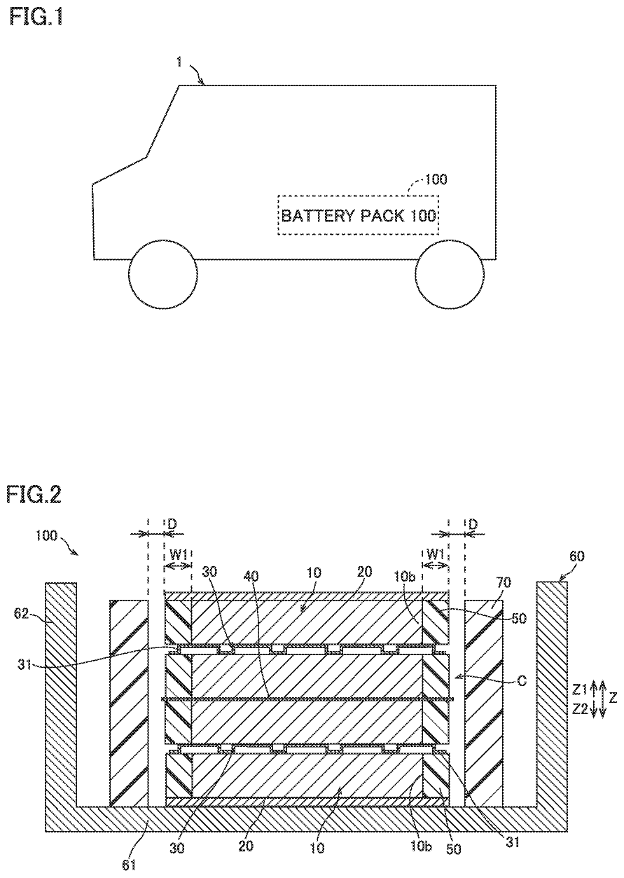

FIG. 1 is a diagram showing an electric vehicle 1 incorporating a battery pack 100 according to the present embodiment. The electric vehicle 1 is an example of the “vehicle” of the present invention.

As shown in FIG. 2, the battery pack 100 includes a plurality of battery modules 10 stacked in the Z direction. In the example shown in FIG. 2, four battery modules 10 are stacked. The battery module 10 and the Z direction are examples of the “stack” and the “first direction” of the present invention, respectively.

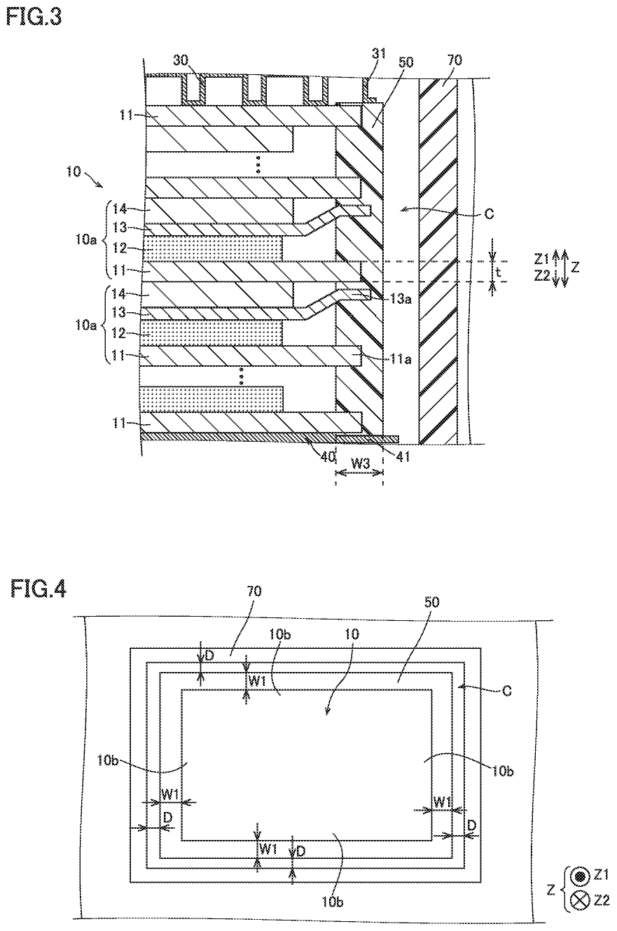

The battery pack 100 includes a pair of restraining plates 20. The pair of restraining plates 20 fix the battery modules 10 by sandwiching the four battery modules 10 in the Z direction using a jig (not shown). As shown in FIG. 3, the battery module 10 includes a plurality of blocks 10a each including a metal foil 11, a negative electrode 12, an adhesive separator 13, and a positive electrode 14. In each of the plurality of blocks 10a, the metal foil 11, the negative electrode 12, the adhesive separator 13, and the positive electrode 14 are laminated in this order from the Z2 side. The metal foil 11 is an example of the “metal plate” in the present invention.

In the battery module 10, a plurality of(for example, 30) blocks 10a are stacked in the Z direction. A metal foil 11 is disposed on the Z1 side of the plurality of battery modules 10. That is, the battery module 10 is configured such that the metal foil 11 is disposed at a position closest to the Z1 side among the plurality of blocks 10a. Accordingly, each of the plurality of battery modules 10 is provided so as to be sandwiched between the metal foils 11 in the Z direction. The metal foil 11 closest to the Z1 side and the Z2 side functions as an active portion for electrically connecting to the battery modules 10 stacked in the Z direction via a cooling plate 30 and a conductive plate 40, which will be described later. The current flows from the battery module 10 on the Z1 side to the battery module 10 on the Z2 side.

The metal foil 1i1 includes, for example, an aluminum foil. Copper plating is applied to the surface of the aluminum foil on the Z1 side. The adhesive separator 13 has a function of separating the positive electrode 14 and the negative electrode 12 from each other and bonding the positive electrode 14 and the negative electrode 12 to each other.

As shown in FIG. 2, the battery pack 100 includes a cooling plate 30 and a conductive plate 40. The cooling plate 30 and the conductive plate 40 are provided so as to be sandwiched between the battery modules 10 stacked in the Z direction. The cooling plate 30 is in contact with each of the pair of battery modules 10 sandwiching the cooling plate 30. The conductive plate 40 is in contact with each of the pair of battery modules 10 sandwiching the conductive plate 40. Thus, the pair of battery modules 10 are electrically connected. The cooling plate 30 cools each of the pair of battery modules 10. The cooling plate 30 and the conductive plate 40 are provided at different positions in the Z direction. The cooling plate 30 and the conductive plate 40 are examples of the “conductive plate” of the present invention.

The battery pack 100 includes a resin portion 50 joined to a peripheral portion 10b (see FIG. 1) of a plurality of battery modules 10. Specifically, the resin portion 50 is bonded to each of the peripheral portion 11a (see FIG. 3) of the metal foil 11 and the peripheral portion 13a (see FIG. 3) of the adhesive separator 13. The resin portion 50 is provided in each of the plurality of battery modules 10.

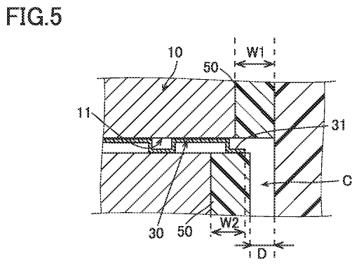

As shown in FIG. 4, the peripheral portions 10b of the plurality of battery modules 10 to which the resin portions 50 are joined are provided over the entire circumference of the plurality of battery modules 10. In other words, the resin portion 50 is provided so as to surround the battery module 10 when viewed along the Z direction.

Referring again to FIG. 2, battery pack 100 includes a case 60 that houses a plurality of battery modules 10. The case 60 has a concave shape. Specifically, the case 60 has a bottom portion 61 in which a plurality of battery modules 10 are disposed. Further, the case 60 has a side surface portion 62 provided so as to surround the entire circumference of the plurality of battery modules 10 when viewed from the Z1 side.

The battery pack 100 includes a stopper 70 that regulates the movement of the plurality of battery modules 10. Specifically, the stopper 70 regulates the movement of the plurality of battery modules 10 in a plane orthogonal to the Z direction. The stopper 70 is an example of the “regulation portion” in the present invention.

The stopper 70 is disposed between the side surface portion 62 of the case 60 and the plurality of battery modules 10. Specifically, as shown in FIG. 4, the stopper 70 is provided so as to surround the entire circumference of the resin portion 50 when viewed along the Z direction (when viewed from the Z1 side).

The stopper 70 is made of an insulating resin. The stopper 70 may be made of a relatively softer resin than metal or the like. Thereby, damage to the battery module 10 when the battery module 10 collides with the stopper 70 due to lateral slip (movement in a plane orthogonal to the Z direction) can be suppressed.

The battery module 10 has a rectangular shape when viewed from the Z1 side. Accordingly, the resin portion 50 and the stopper 70 are opposed to each other in the directions orthogonal to the four sides of the battery module 10. The direction in which the resin portion 50 and the stopper 70 face each other is an example of the “second direction” in the present invention.

Here, in the conventional battery pack, when any one of the plurality of battery modules slides due to vibration of the vehicle or the like, an electrical connection surface (active portion) of the battery module may be exposed. Therefore, it is desirable to suppress exposure of the active portion of the battery module.

Therefore, in the present embodiment, as shown in FIG. 2, the width W1 of the resin portion 50 in the direction in which the resin portion 50 and the stopper 70 face each other is equal to or greater than the distance D between the resin portion 50 and the stopper 70. In the example shown in FIG. 2, the width W1 of the resin portion 50 is larger than the distance D between the resin portion 50 and the stopper 70. The width W1 of the resin portion 50 means the maximum value of the width of the resin portion 50 (the width of the portion where the metal foil 11 and the adhesive separator 13 are not bonded to each other).

As a result, even when one battery module 10 slides and collides with the stopper 70 as shown in FIG. 5, the metal foil 11, which is the active portion of the battery module 10, can be prevented from moving to the gap C between the resin portion 50 and the stopper 70.

The cooling plate 30 has an overlapping portion 31 provided so as to overlap the resin portion 50 in the Z direction. The conductive plate 40 has an overlapping portion 41 (see FIG. 3) provided so as to overlap the resin portion 50 in the Z direction. The overlapping portion 31 (41) is a portion overlapping the resin portion 50 bonded to the battery module 10 disposed at a prescribed position without slipping in the Z direction.

In the present embodiment, the width W2 (see FIG. 5) of the overlapping portion 31 of the cooling plate 30 in the direction in which the resin portion 50 and the stopper 70 face each other is equal to or greater than the distance D between the resin portion 50 and the stopper 70. Specifically, the width W2 of the overlapping portion 31 is larger than the distance D between the resin portion 50 and the stopper 70. The width W2 is smaller than the width W1 of the resin portion 50.

As a result, as shown in FIG. 5, even when one battery module 10 slides and collides with the stopper 70, the metal foil 11, which is the active portion of the battery module 10, can be prevented from protruding beyond the cooling plate 30 (overlapping portion 31) toward the stopper 70.

The width W3 (see FIG. 3) of the overlapping portion 41 of the conductive plate 40 in the direction in which the resin portion 50 and the stopper 70 face each other is larger than the distance D between the resin portion 50 and the stopper 70. In the example shown in FIG. 3, the width W3 is equal to the width W1 of the resin portion 50.

Further, as shown in FIG. 4, the resin portion 50 is formed such that a width W1 of a portion of the resin portion 50 facing the stopper 70 over the entire circumference in the opposing direction is larger than a distance D of the resin portion 50 and the stopper 70 in the opposing direction. Similarly, the width W2 (W3) of the overlapping portion 31 (41) in the facing direction is larger than the distance D over the entire circumference. The opposing direction is an example of the “second direction” in the present invention.

The width W1 of the resin portion 50 is larger than the thickness t (see FIG. 3) of the metal foil 11 in the Z direction. The width W1 of the resin portion 50 may be larger than the thickness (not shown) of the negative electrode 12, the adhesive separator 13, the positive electrode 14, the cooling plate 30, and the conductive plate 40 in the Z direction.

As described above, in the present embodiment, in the direction in which the resin portion 50 and the stopper 70 face each other, the width W1 of the resin portion 50 is equal to or greater than the distance D between the resin portion 50 and the stopper 70. This makes it possible to reduce the amount of movement (distance of lateral slip) of the resin portion 50 as compared with the case where the distance D is larger than the width W1 of the resin portion 50. As a result, exposure of the active portion of the battery module 10 can be easily suppressed.

In the above embodiment, the width W2 (W3) of the overlapping portion 31 (41) of the cooling plate 30 (conductive plate 40) is equal to or greater than the distance D between the resin portion 50 and the stopper 70. When the width W1 of the resin portion 50 is equal to or greater than the distance D, the width W2 (W3) of the overlapping portion 31 (41) may be smaller than the distance D.

In the above embodiment, the width W1 of the resin portion 50 is larger than the distance D between the resin portion 50 and the stopper 70. The width W1 of the resin portion 50 may be equal to the distance D. The width W2 (W3) of the overlapping portion 31 (41) may be equal to the distance D.

In the above embodiment, the width W1 of the resin portion 50 is formed over the entire circumference so as to be equal to or greater than the distance D between the resin portion 50 and the stopper 70. The width W1 of the resin portion 50 may be equal to or greater than the distance D in only a part of the entire circumference of the resin portion 50.

In the above embodiment, the width W1 of the resin portion 50 is larger than the thickness t of the metal foil 11, but the present invention is not limited thereto. The width W1 of the resin portion 50 may be equal to or less than the thickness t of the metal foil 11.

Although the stopper 70 is made of resin in the above embodiment, the present invention is not limited thereto. The stopper 70 may be made of a material other than resin (Examples of the material include metal and rubber.).

In the above embodiment, the battery pack 100 is mounted on the electric vehicle 1, but the present invention is not limited thereto. The battery pack 100 may be mounted on a device other than an electric vehicle (for example, a stationary power storage device).

In the above embodiment, the stopper 70 is provided between the resin portion 50 and the case 60 (the side surface portion 62). The stopper 70 may be disposed on the surface of the side surface portion 62.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery pack comprising:
a plurality of stacks stacked in a first direction, and each including a plurality of metal plates stacked in the first direction;
a resin portion bonded to a peripheral portion of the plurality of stacks;
a case that houses the plurality of stacks; and
a regulating portion that is disposed in the case so as to face the resin portion in a second direction orthogonal to the first direction and regulates movement of each of the plurality of stacks,
in the second direction, the resin portion having a width equal to or larger than a distance between the resin portion and the regulating portion.

2. The battery pack according to claim 1, further comprising a conductive plate adjacent to at least one of the plurality of stacks in the first direction and thus electrically connected to the at least one stack, wherein
the conductive plate has an overlapping portion provided so as to overlap the resin portion in the first direction, and
in the second direction, the overlapping portion has a width equal to or larger than the distance between the resin portion and the regulating portion.

3. The battery pack according to claim 1, wherein
the peripheral portion of the plurality of stacks to which the resin portion is bonded is provided along an entirety of a periphery of the plurality of stacks,
the regulating portion is provided so as to surround an entirety of a periphery of the resin portion when viewed in the first direction, and
the resin portion is formed such that, along the entirety of the periphery thereof, a width of the resin portion in the second direction opposing the regulating portion is equal to or larger than the distance between the resin portion and the regulating portion in the second direction.

4. The battery pack according to claim 1, wherein the width of the resin portion in the second direction is larger than a thickness of each of the plurality of metal plates in the first direction.

5. The battery pack according to claim 1, wherein the regulating portion is formed of an insulating resin.

6. A vehicle comprising a battery pack according to claim 1.
